(19) United States
(12) Patent Application Publication
(10) Pub. No.: US 2018/0224002 A1
(43) Pub. Date: Aug. 9, 2018

(54) ENGINE VALVE

(71) Applicant: TOYOTA JIDOSHA KABUSHIKI KAISHA, Toyota-shi (JP)

(72) Inventor: Shouji KATSUMATA, Gotenba-shi (JP)

(73) Assignee: TOYOTA JIDOSHA KABUSHIKI KAISHA, Toyota-shi (JP)

(21) Appl. No.: 15/851,897

(22) Filed: Dec. 22, 2017

(30) Foreign Application Priority Data
Feb. 8, 2017 (JP) 2017-021489

(51) Int. Cl. F16K 1/36; F16K 1/12

(52) U.S. Cl. CPC F16K 1/36; F16K 1/12

(57) ABSTRACT

An engine valve for an internal-combustion engine includes: a head part including a main surface facing a combustion chamber of the internal-combustion engine and a valve face coming in contact with a valve seat; a stem part extending along a direction of movement of the engine valve; and a neck part between the head part and the stem part. A material of the stem part is heat-resistant steel. A material of the head part is a high-λ material such as aluminum, an aluminum alloy, tungsten steel, chrome steel, low-chrome steel, and low-carbon steel.

### BACKGROUND

### Technical Field

The present disclosure relates to an engine valve for an internal-combustion engine.

### Background Art

The followings are known as background art documents relating to a material of an engine valve (i.e. an intake valve or an exhaust valve) for an internal-combustion engine.

Patent Literature 1 discloses a titanium metal-based engine valve. More specifically, a main body of the engine valve is made of Ti—Al intermetallic compound. A stem end portion of the engine valve is in contact with a cam. The stem end portion is made of heat-resistant steel such as SUH3, SUH11, and the like.

Patent Literature 2 discloses an intake valve. A main body of the intake valve is made of an aluminum alloy. A valve face of a head part of the intake valve comes in contact with a valve seat. A thermally-hardened layer is formed at a surface of the valve face. Furthermore, an alloy layer containing a strengthening element (any of Ti, Cr, Ni, Cu, Mn, Fe, and Co) is formed below the thermally-hardened layer.

Patent Literature 3 discloses an intake valve. A framework part and a stem part of the intake valve is made of an iron-based material such as SUH3, SUH11, and the like. A ring part included in the framework part comes in contact with a valve seat. A part around the framework part is made of an aluminum alloy.

Patent Literature 4 discloses an exhaust valve. A head part of the exhaust valve is made of heat-resistant steel such as SUH1, SUH3, and the like. A stem part of the exhaust valve is made of titanium or a titanium alloy. Furthermore, a metallic molybdenum sprayed layer is formed to cover from an almost entire surface of the stem part to a part of the head part.

### LIST OF RELATED ART

Patent Literature 1: Japanese Laid-Open Patent Publication No. H08-144722
Patent Literature 2: Japanese Laid-Open Patent Publication No. H11-62525
Patent Literature 3: Japanese Laid-Open Patent Publication No. 2012-162999
Patent Literature 4: Japanese Laid-Open Patent Publication No. S62-41908

### SUMMARY

The inventor of the present invention has noticed the following points. That is, when a temperature of an engine valve increases, knocking is more likely to occur in a combustion chamber. To decrease the temperature of the engine valve is effective for suppressing the knocking. In order to decrease the temperature of the engine valve, it is effective to transfer as much heat as possible from the engine valve to a valve seat. However, in the cases of the background arts mentioned above, heat transfer from the engine valve to the valve seat is not sufficient. There is still room for improvement in the heat transfer from the engine valve to the valve seat.

An object of the present disclosure is to provide a technique that can facilitate heat transfer from an engine valve to a valve seat.

In an aspect of the present disclosure, an engine valve for an internal-combustion engine is provided.

The engine valve includes:
a head part having: a main surface facing a combustion chamber of the internal-combustion engine; and a valve face coming in contact with a valve seat;
a stem part extending along a direction of movement of the engine valve; and
a neck part between the head part and the stem part.

A material of the stem part is heat-resistant steel.

A material of the head part is aluminum or an aluminum alloy.

In another aspect of the present disclosure, an engine valve for an internal-combustion engine is provided.

The engine valve includes:
a head part having: a main surface facing a combustion chamber of the internal-combustion engine; and a valve face coming in contact with a valve seat;
a stem part extending along a direction of movement of the engine valve; and
a neck part between the head part and the stem part.

A material of the stem part is heat-resistant steel.

A material of the head part is any of tungsten steel, chrome steel, low-chrome steel, and low-carbon steel.

In still another aspect of the present disclosure, an engine valve for an internal-combustion engine is provided.

The engine valve includes:
a head part having: a main surface facing a combustion chamber of the internal-combustion engine; and a valve face coming in contact with a valve seat;
a stem part extending along a direction of movement of the engine valve; and
a neck part between the head part and the stem part.

A material of the stem part is heat-resistant steel.

An inverse of thermal conductivity λ of a material of the head part at 100 degrees centigrade is in a range of 0.01 (m˜K/W) to 0.04 (m˜K/W).

According to the present disclosure, the stem part of the engine valve is made of the heat-resistant steel, and the head part thereof is made of a high-λ material (such as aluminum, an aluminum alloy, tungsten steel, chrome steel, low-chrome steel, low-carbon steel, and the like) having higher thermal conductivity λ than the heat-resistant steel. In other words, the thermal conductivity λ of the stem part is lower than the thermal conductivity λ of the head part. Therefore, heat is hard to transfer from the head part to the stem part, and thus heat transfer to the valve seat through the valve face is facilitated. As a result, a temperature of the engine valve decreases effectively. Due to decrease in the temperature of the engine valve, a temperature of the combustion chamber also decreases and thus knocking is suppressed.

### BRIEF DESCRIPTION OF DRAWINGS

FIG. 1 is a cross-sectional diagram schematically showing a configuration of an internal-combustion engine according to an embodiment of the present disclosure;

FIG. 2 is a schematic diagram for explaining a structure of an intake valve of the internal-combustion engine according to the embodiment of the present disclosure;

FIG. 3 is a conceptual diagram for explaining an effect caused by the intake valve according to the embodiment of the present disclosure;

FIG. 4 is a graph chart for explaining an effect caused by the intake valve according to the embodiment of the present disclosure;

FIG. 5 is a conceptual diagram for explaining an effect caused by the intake valve according to the embodiment of the present disclosure;

FIG. 6 is a graph chart for explaining an effect caused by the intake valve according to the embodiment of the present disclosure;

FIG. 7 is a graph chart for explaining an effect caused by the intake valve according to the embodiment of the present disclosure;

FIG. 8 is a diagram showing a first example of a first material in the intake valve according to the embodiment of the present disclosure;

FIG. 9 is a graph chart for explaining an effect caused by the intake valve according to the embodiment of the present disclosure;

FIG. 10 is a diagram showing a second example of a first material in the intake valve according to the embodiment of the present disclosure;

FIG. 11 is a graph chart showing tensile strength of various materials;

FIG. 12 is a schematic diagram showing an example of a structure of the intake valve according to the embodiment of the present disclosure;

FIG. 13 is a schematic diagram showing another example of a structure of the intake valve according to the embodiment of the present disclosure;

FIG. 14 is a schematic diagram showing still another example of a structure of the intake valve according to the embodiment of the present disclosure;

FIG. 15 is a schematic diagram showing a modification example of the structure of the intake valve shown in FIG. 14; and

FIG. 16 is a schematic diagram showing another modification example of the structure of the intake valve shown in FIG. 14.

### EMBODIMENTS

Embodiments of the present disclosure will be described below with reference to the attached drawings.

### 1. Outline

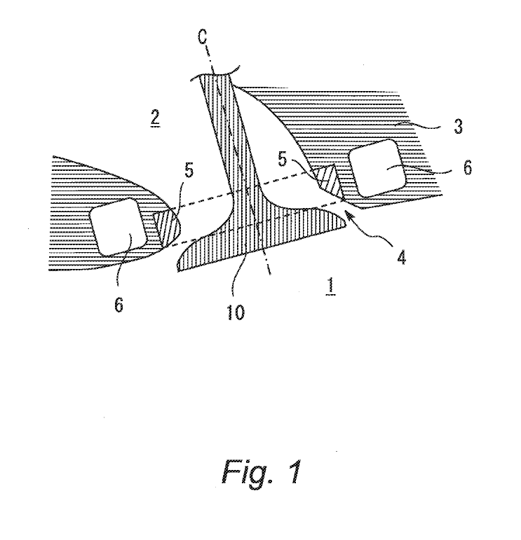

FIG. 1 is a cross-sectional diagram schematically showing a configuration of an internal-combustion engine according to an embodiment of the present disclosure. The internal-combustion engine includes a combustion chamber 1. An intake port 2 is provided for supplying intake gas to the combustion chamber 1. More specifically, the intake port 2 is formed within the cylinder head 3 and connected to the combustion chamber 1 at an intake opening 4.

The intake valve 10 is an engine valve used for controlling communication between the combustion chamber 1 and the intake port 2. More specifically, the intake valve 10 opens and closes by reciprocating along an axis C shown in FIG. 1. When the intake valve 10 opens, the combustion chamber 1 and the intake port 2 communicate with each other, and the intake gas is introduced from the intake port 2 into the combustion chamber 1. On the other hand, when the intake valve 10 closes, the intake opening 4 is covered by the intake valve 10, and thus communication between the combustion chamber 1 and the intake port 2 is interrupted.

A valve seat 5 is provided at the cylinder head 3 around the intake opening 4. When the intake valve 10 closes, a part of the intake valve 10 comes in contact with the valve seat 5 and thereby the intake opening 4 is covered.

Moreover, a cooling water channel 6 (water jacket) for cooling the cylinder head 3 is formed within the cylinder head 3. As shown in FIG. 1, the cooling water channel 6 is disposed around the valve seat 5 as well so as to efficiently cool the valve seat 5.

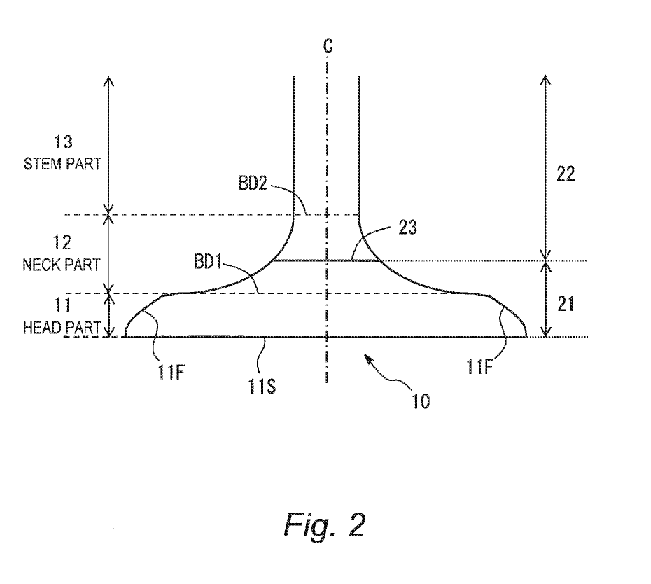

FIG. 2 is a schematic diagram for explaining a structure of the intake valve 10 according to the present embodiment. The intake valve 10 includes a head part 11, a neck part 12, and a stem part 13.

Among the intake valve 10, the head part 11 is located closest to the combustion chamber 1. That is, the head part 11 has a main surface 11S facing the combustion chamber 1. The main surface 11S is perpendicular to the axis C, that is, the direction of movement of the intake valve 10. The head part 11 is formed to spread out to be able to cover the intake opening 4. When the intake valve 10 closes, the head part 11 comes in contact with the above-described valve seat 5 to cover the intake opening 4. A surface of the head part 11 coming in contact with the valve seat 5 is hereinafter referred to as a “valve face 11F”. As shown in FIG. 2, a peripheral edge portion of the head part 11 is formed in a tapered shape, and the tapered slope corresponds to the valve face 11F.

The stem part 13, which is also called a “stem”, is a rod-shaped part extending along the axis C, that is, the direction of movement of the intake valve 10. The neck part 12 is a part between the head part 11 and the stem part 13. In the example shown in FIG. 2, a side surface of the neck part 12 curves so as to connect between the valve face 11F of the head part 11 and a side surface of the stem part 13.

In FIG. 2, a boundary between the head part 11 and the neck part 12 is denoted by “BD1”, and a boundary between the neck part 12 and the stem part 13 is denoted by “BD2”. It should be noted that the boundary BD1 and the boundary BD2 each is for convenience of explanation and does not necessarily mean a physical boundary. That is, the head part 11 and the neck part 12 are neither necessarily made of different materials nor are necessarily different members. Similarly, the neck part 12 and the stem part 13 are neither necessarily made of different materials nor are necessarily different members.

The intake valve 10 according to the present embodiment is sectioned into two parts in terms of material. The first part is a first material part 21 made of a first material. The second part is a second material part 22 made of a second material different from the first material. The first material part 21 and the second material part 22 are joined to each other at a joint surface 23.

More specifically, the first material part 21 includes at least a whole of the head part 11. On the other hand, the second material part 22 includes at least the stem part 13. The neck part 12 may belong to the first material part 21 or may belong to the second material part 22. It is also possible that a part of the neck part 12 belongs to the first material part 21 and the rest of the neck part 12 belongs to the second material part 22. In other words, the joint surface 23 between the first material part 21 and the second material part 22 may be located at any of the boundary BD1, a middle of the neck part 12, and the boundary BD2.

In the present embodiment, the second material being the material of the stem part 13 is “heat-resistant steel” which is excellent in high-temperature strength an abrasion resistance. The second material is exemplified by SUH3, SUH1, SUH11, and the like. On the other hand, the first material being the material of the head part 11 is a “high-λ material” having higher thermal conductivity λ than the second material. The first material (i.e. the high-λ, material) is exemplified by aluminum, an aluminum alloy, tungsten steel, chrome steel, low-chrome steel, low-carbon steel, and the like.

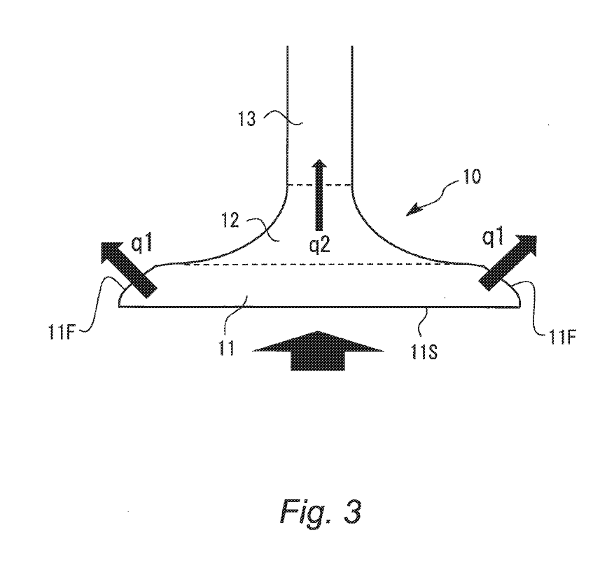

FIG. 3 is a conceptual diagram for explaining an effect caused by the intake valve 10 according to the present embodiment. Heat flows from the combustion chamber 1 into the intake valve 10 mainly through the main surface 11S of the head part 11. A part of the heat flowed into the intake valve 10 escapes to the valve seat 5 through the valve face 11F of the head part 11. The heat flow from the head part 11 to the valve seat 5 is indicated by “q1” in FIG. 3. Meanwhile, another part of the heat flowed into the intake valve 10 is transmitted to the stem part 13 through the neck part 12. The heat flow from the head part 11 toward the stem part 13 is indicated by “q2” in FIG. 3.

In order to decrease a temperature of the intake valve 10, it is necessary to let the heat flowed into the intake valve 10 out of the intake valve 10. For that purpose, it is effective to transfer as much heat as possible to the valve seat 5 through the valve face 11F. In other words, it is effective to increase the heat flow q1 from the head part 11 to the valve seat 5 as much as possible. In order to increase the heat flow q1, the present embodiment decreases the heat flow q2 towards the stem part 13.

According to the present embodiment, as described above, the stem part 13 is made of the heat-resistant steel, and the head part 11 is made of the high-λ material having higher thermal conductivity λ than the heat-resistant steel. In other words, the thermal conductivity λ of the stem part 13 is lower than the thermal conductivity λ of the head part 11. Therefore, heat is hard to transfer from the head part 11 to the stem part 13, and thus heat transfer to the valve seat 5 through the valve face 11F is facilitated. That is, the heat flow q2 towards the stem part 13 is suppressed, while the heat flow q1 from the head part 11 to the valve seat 5 is facilitated. As a result, the temperature of the intake valve 10 decreases effectively. Due to decrease in the temperature of the intake valve 10, a temperature of the combustion chamber 1 also decreases and thus knocking is suppressed.

In addition, among the intake valve 10, a temperature of the neck part 12 in particular affects a temperature of the intake gas in the intake port 2 (see FIG. 1) around the neck part 12. According to the present embodiment, the temperature of the neck part 12 decreases, since the heat flow q1 from the head part 11 to the valve seat 5 is increased and the heat flow q2 towards the stem part 13 is suppressed. As the temperature of the neck part 12 decreases, the temperature of the intake gas in the intake port 2 around the neck part 12 also decreases. Since the temperature of the intake gas supplied to the combustion chamber 1 decreases, the knocking is further suppressed.

It should be noted that the application of the valve structure according to the present embodiment is not limited to the intake valve 10. It is also possible to apply the valve structure according to the present embodiment to an exhaust valve (not shown) of the internal-combustion engine. The exhaust valve is an engine valve used for controlling communication between the combustion chamber 1 and an exhaust port. Due to decrease in a temperature of the exhaust valve, the temperature of the combustion chamber 1 also decreases and thus knocking is suppressed.

### 2. Various Examples of First Material (High-λ Material)

### 2-1. First Example

In the first example, the first material constituting the head part 11 is aluminum or an aluminum alloy. Hereinafter, an effect of the first example will be described.

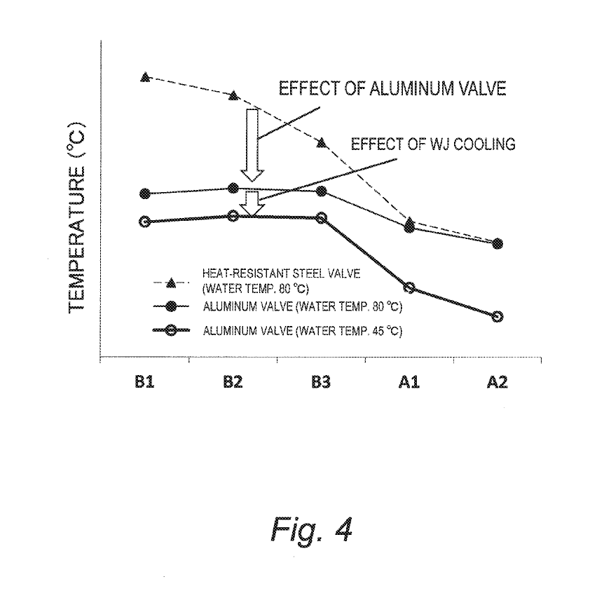

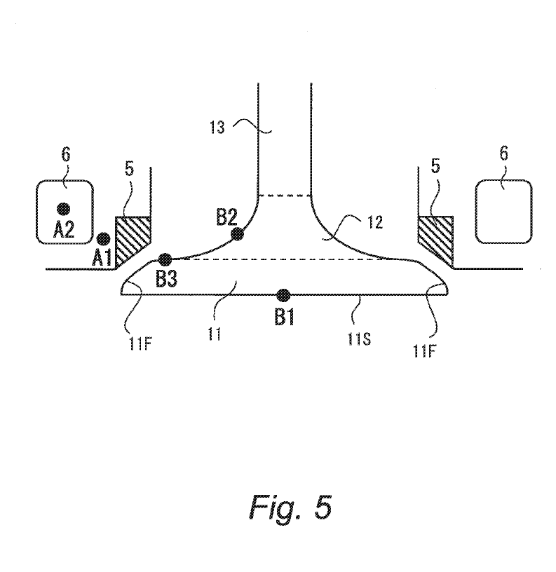

FIG. 4 is a graph chart showing a temperature distribution in the intake valve 10 and its surroundings. A vertical axis represents the temperature, and a horizontal axis represents positions (B1, B2, B3, A1, and A2) at which the temperature is measured. The positions (B1, B2, B3, A1, and A2) are shown in FIG. 5. The position B1 is a position on the main surface 11S of the head part 11. The position B2 is a position on a curved section on a back side of the head part 11, that is, a curved section of the neck part 12. The position B3 is a position where the neck part 12 starts and which is slightly apart from the valve face 11F of the head part 11. The position A1 is a position between the valve seat 5 and the cooling water channel 6. The position A2 is a position in the cooling water channel 6 around the valve seat 5.

A line denoted by “ALUMINUM VALVE” in FIG. 4 represents the temperature distribution in the case of the intake valve 10 according to the present embodiment. In order to explain an effect of the present embodiment, let us consider a comparative example. In the comparative example, both the first material and the second material are SUH3 (i.e. heat-resistant steel). A dashed line denoted by “HEAT-RESISTANT STEEL VALVE” in FIG. 4 represents the temperature distribution in the case of the comparative example.

As can be clearly seen from FIG. 4, the temperature of the intake valve 10 according to the present embodiment is significantly lower than the temperature in the case of the comparative example. Especially, pay attention to decrease in the temperature at the position B2. The position B2 is not located between the main surface 11S and the valve face 11F but is located between the main surface 11S and the stem part 13 (see FIG. 5). Therefore, the decrease in the temperature at the position B2 means decrease in the temperature of the stem part 13, that is, decrease in the heat flow q2 towards the stem part 13 (see FIG. 3). Since the heat flow q2 towards the stem part 13 decreases and thus the heat flow q1 from the head part 11 to the valve seat 5 is facilitated, the temperature of the intake valve 10 decreases effectively. Due to decrease in the temperature of the intake valve 10, knocking is suppressed.

FIG. 4 further shows dependence of the valve temperature distribution on the cooling water temperature at the position A2 (i.e. the cooling water channel 6 around the valve seat 5). When the cooling water temperature at the position A2 decreases from 80 degrees centigrade to 45 degrees centigrade, its cooling effect increases and thus the temperatures of the valve seat 5 and the intake valve 10 decrease further.

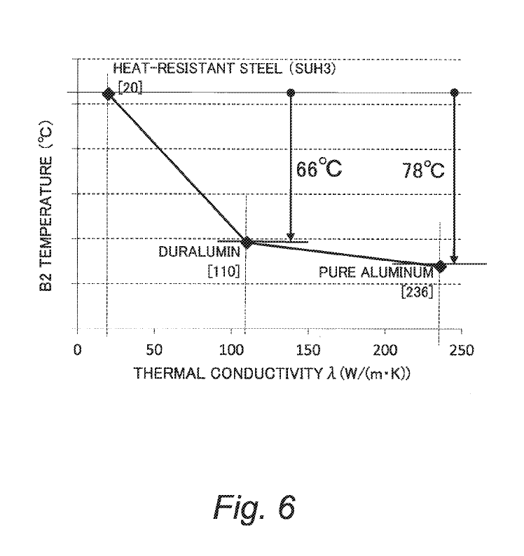

FIG. 6 shows a calculation result of the temperature at the position B2 in the cases of the present embodiment and the comparative example. A horizontal axis represents the thermal conductivity λ. A vertical axis represents the temperature at the position B2 (hereinafter referred to as a “B2 temperature”). Two kinds of materials, pure aluminum having the thermal conductivity λ of 236 [W/(m·K)] and duralumin having the thermal conductivity λ of 110 [W/(m·K)] are considered as the first material in the case of the present embodiment. The thermal conductivity λ of SUH3 in the case of the comparative example is 20 [W/(m·K)]. Note that each value of the thermal conductivity λ is a value at 100 degrees centigrade. Also in the description below, unless otherwise noted, a value of the thermal conductivity λ is a value at 100 degrees centigrade.

As shown in FIG. 6, the B2 temperature when the first material is pure aluminum is lower than the comparative example by as much as 78 degrees centigrade. Even when the first material is duralumin, the B2 temperature is lower than the comparative example by 66 degrees centigrade. As seen above, the B2 temperature decreases remarkably due to the first material according to the first example. Moreover, it can be seen that a sufficient temperature decrease effect can be obtained even when duralumin is used instead of expensive pure aluminum.

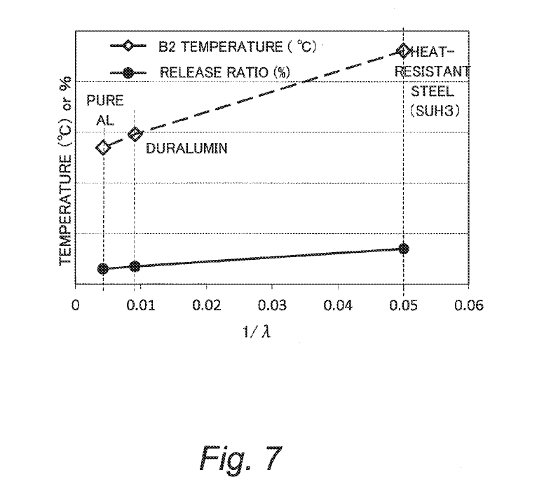

FIG. 7 also shows a calculation result of the B2 temperature in the cases of the present embodiment and the comparative example. A horizontal axis represents an inverse (1/λ) of the thermal conductivity λ, and a vertical axis represents the B2 temperature. The parameter 1/λ of SUH3 in the case of the comparative example is 0.05 [m·K/W]. On the other hand, the parameter 1/λ of each of pure aluminum and duralumin in the case of the present embodiment is lower than 0.01 [m·K/W]. As shown in FIG. 7, as the parameter 1/λ becomes smaller, the B2 temperature becomes lower, that is, the temperature decrease effect becomes stronger.

FIG. 7 further shows a release ratio. The release ratio reflects an amount of heat radiation from the intake valve 10. More specifically, referring to the foregoing FIG. 3, the heat flowed into the intake valve 10 is consumed not only by the above-described heat flows q1 and q2 but also by the heat radiation from the intake valve 10. The release ratio is a ratio of an amount of heat radiated due to the heat radiation other than the heat flows q1 and q2 to a total amount of heat. The release ratio is a function of the temperature of the intake valve 10 and becomes higher as the temperature of the intake valve 10 becomes higher. Therefore, as shown in FIG. 7, as the parameter 1/λ becomes larger, the release ratio increases.

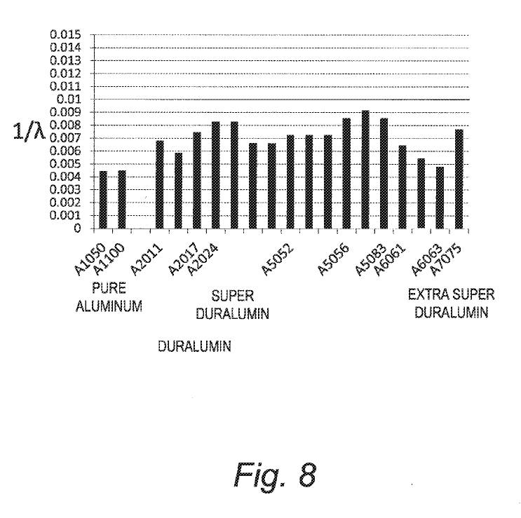

FIG. 8 shows concrete examples of the first material (aluminum or an aluminum alloy) according to the first example and respective 1/λ. The first material according to the first example includes pure aluminum, duralumin, super duralumin, and extra super duralumin. In either case, the parameter 1/λ is less than 0.01 [m·K/W].

As described above, according to the first example, the B2 temperature decreases remarkably as compared with the case of the comparative example. The decrease in the B2 temperature means decrease in the temperature of the stem part 13 and increase in the heat transfer from the head part 11 to the valve seat 5. Therefore, knocking is suppressed effectively.

### 2-2. Second Example

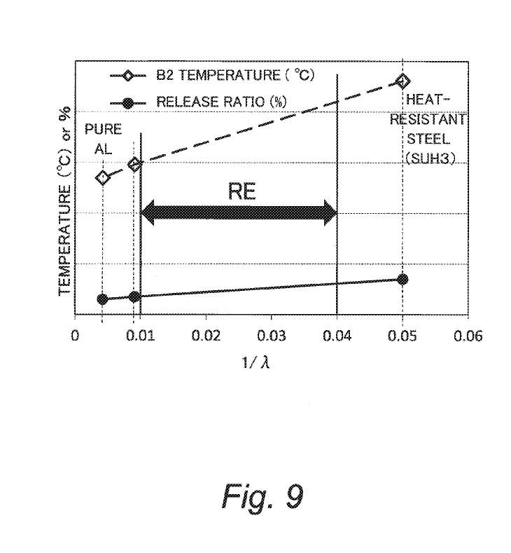

FIG. 9 is a graph chart having the same format as the foregoing FIG. 7. In the first example described above, the first material is aluminum or an aluminum alloy and the parameter 1/λ is less than 0.01 [m·K/W]. In the second example, we consider a range of 1/λ different from the first example, that is, a range RE shown in FIG. 9.

More specifically, a lower limit and an upper limit of the range RE are 0.01 [m·K/W] and 0.04 [m·K/W], respectively. The upper limit of the range RE, which is 0.04 [m·K/W], is smaller than 0.05 [m·K/W] in the case of the comparative example (SUH3). As described above and shown in FIG. 9, the B2 temperature becomes lower, that is, the temperature decrease effect becomes stronger as the parameter 1/λ becomes smaller. Therefore, even in the second example where the parameter 1/λ is within the range RE, the temperature decrease effect can be obtained in comparison with the comparative example. In other words, the range RE also is effective.

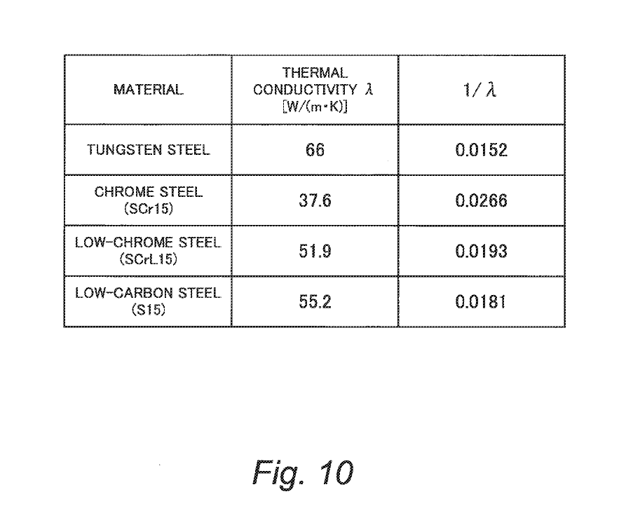

FIG. 10 shows concrete examples of the first material according to the second example. The first material in the second example is exemplified by tungsten steel, chrome steel (SCr15), low-chrome steel (SCrL15), and low-carbon steel (S15). The parameter 1/λ of each material is within the range RE described above. It should be noted that respective values of the thermal conductivity λ and the parameter 1/λ shown in FIG. 10 are values at 100 degrees centigrade.

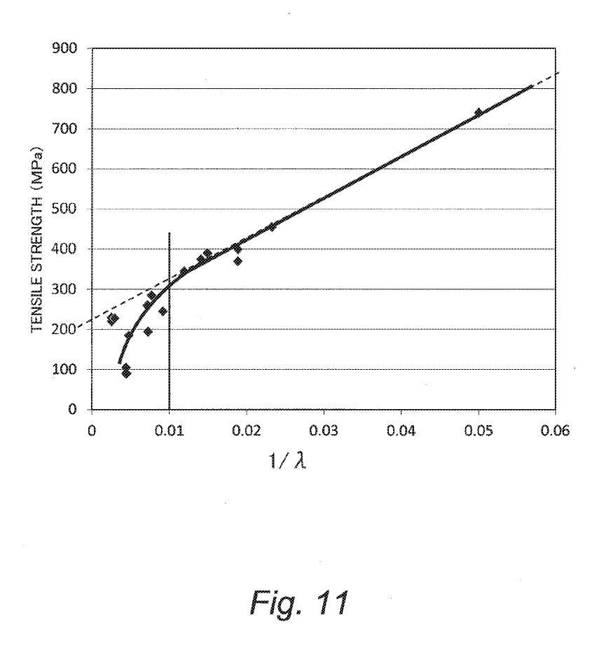

FIG. 11 is a graph chart showing tensile strength of various materials. A vertical axis represents the tensile strength, and a horizontal axis represents the parameter 1/λ. As shown in FIG. 11, the tensile strength decreases as the parameter 1/λ becomes lower, that is, the thermal conductivity λ becomes higher. Especially, when the parameter 1/λ becomes less than 0.01 [m·K/W], the tensile strength decreases rapidly. Therefore, it can be said that the range RE in which the parameter 1/λ is 0.01 [m·K/W] or more is preferable from a viewpoint of the tensile strength.

According to the second example, as described above, the B2 temperature decreases in comparison with the case of the comparative example. That is, even in the second example, the heat transfer from the head part 11 to the valve seat 5 is facilitated and thus the effect of suppressing knocking can be obtained.

Furthermore, the following effect can be obtained according to the second example. That is, the steel-based material (such as tungsten steel, chrome steel, low-chrome steel, and low-carbon steel) in the second example is superior to the material (i.e. aluminum and an aluminum alloy) in the first example in terms of strength, tensile strength, abrasion resistance, and the like. Therefore, durability of the intake valve 10 is increased and abrasion of the valve face 11F is suppressed, as compared with the case of the first example. Moreover, the steel-based material in the second example is superior to the first example in terms of cost as well.

### 2-3. Comparison with Patent Literatures 1 to 4

Hereinafter, we discuss respective valve structures in the cases of Patent Literatures 1 to 4 mentioned above.

In Patent Literature 1 (JP-H08-144722), a main body of the engine valve is made of Ti—Al intermetallic compound. Although strength is secured by the intermetallic compound, heat transfer to the valve seat is not facilitated.

In Patent Literature 2 (JP-H11-62525), a thermally-hardened layer is formed on the valve face, although a main body of the intake valve is made of an aluminum alloy. Furthermore, an alloy layer containing a strengthening element is formed below the thermally-hardened layer. The thermal conductivity λ of each of the thermally-hardened layer and the alloy layer is lower than the thermal conductivity λ of the aluminum alloy (intake valve main body). Therefore, the thermally-hardened layer and the alloy layer work to hinder the heat transfer to the valve seat. Meanwhile, a stem part of the intake valve is made of the aluminum alloy and its thermal conductivity λ is high. Accordingly, heat flowed into the intake valve flows towards the stem part rather than towards the valve face. That is to say, in the case of Patent Literature 2, not the heat transfer towards the valve seat but the heat transfer towards the stem part is facilitated. This is totally opposite to tendency of the heat transfer in the present embodiment.

In Patent Literature 3 (JP-2012-162999) and Patent Literature 4 (JP-S62-41908), the valve face coming in contact with the valve seat is made of heat-resistant steel such as SUH3 and the like. This is the same as the above-described comparative example.

### 3. Various Examples of Joint Surface Position

Hereinafter, various examples of a position of the joint surface 23 between the first material part 21 and the second material part 22 will be described.

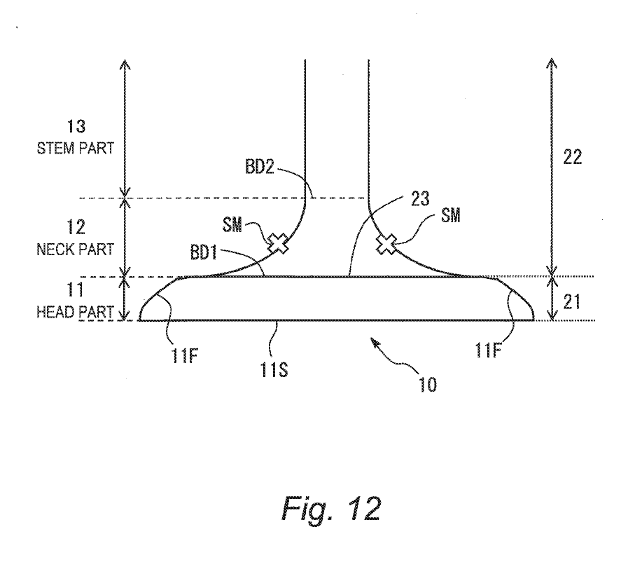

FIG. 12 is a schematic diagram showing an example of a structure of the intake valve 10 according to the present embodiment. In the example shown in FIG. 12, the joint surface 23 is located at the boundary BD1 between the head part 11 and the neck part 12. That is, the head part 11 is made of the first material, and the neck part 12 and the stem part 13 are made of the second material (i.e. the heat-resistant steel). Here, let us consider stress applied to the intake valve 10. As shown in FIG. 12, a maximum stress position SM where the stress takes the maximum value exists at a curved section at a middle of the neck part 12. Since the material of the neck part 12 is the heat-resistant steel with high strength, the maximum stress position SM is located within the heat-resistant steel with high strength. This is preferable from a viewpoint of durability of the intake valve 10.

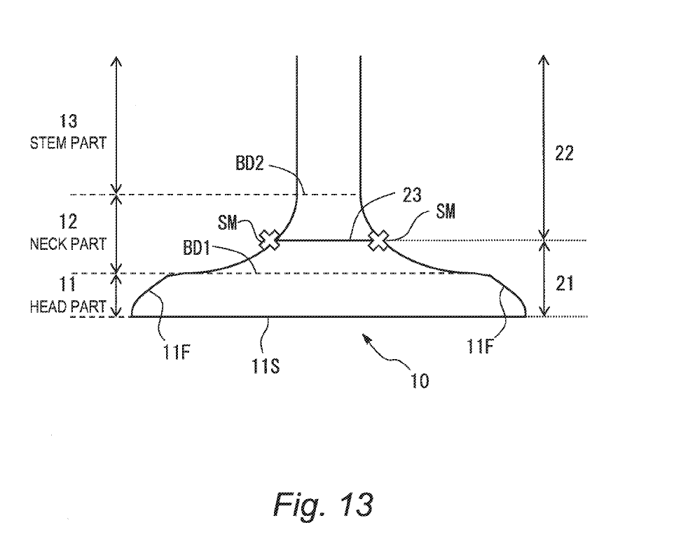

FIG. 13 is a schematic diagram showing another example of a structure of the intake valve 10 according to the present embodiment. In the example shown in FIG. 13, the joint surface 23 is located at a middle of the neck part 12. More specifically, the position of the joint surface 23 coincides with the position of the maximum stress position SM. Therefore, joining makes it possible to enhance the strength at the position of the maximum stress position SM. This is preferable from a viewpoint of durability of the intake valve 10.

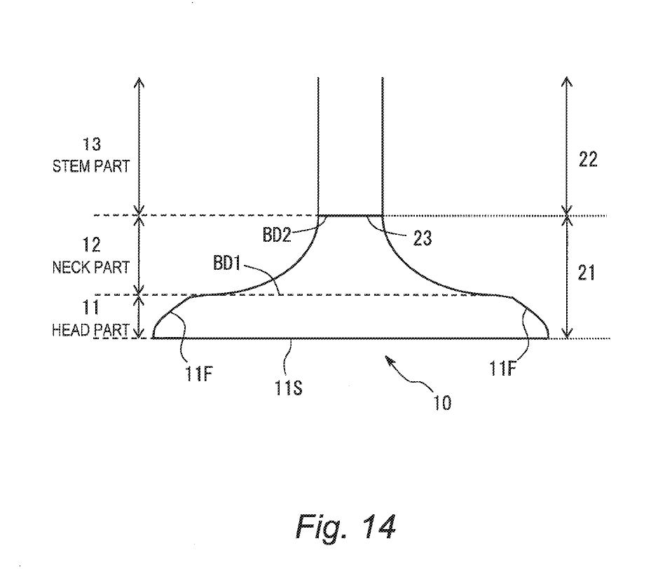

FIG. 14 is a schematic diagram showing still another example of a structure of the intake valve 10 according to the present embodiment. In the example shown in FIG. 14, the joint surface 23 is located at the boundary BD2 between the neck part 12 and the stem part 13. Even with the structure shown in FIG. 14, the effects such as suppression of the heat flow q2 towards the stem part 13 and decrease in the temperature of the stem part 13 can be obtained.

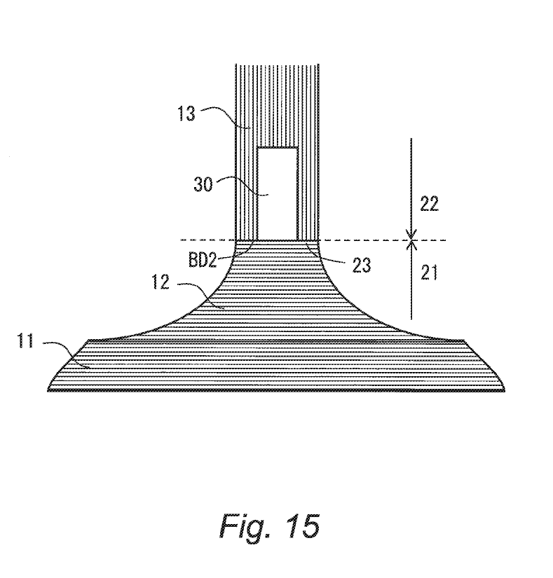

FIG. 15 shows a modification example of the structure of the intake valve 10 shown in FIG. 14. In the modification example shown in FIG. 15, a hollow 30 is formed within the stem part 13 adjacent to the joint surface 23. Due to existence of such the hollow 30, the heat flow q2 towards the stem part 13 is further suppressed and thus the heat transfer towards the valve seat 5 is further facilitated.

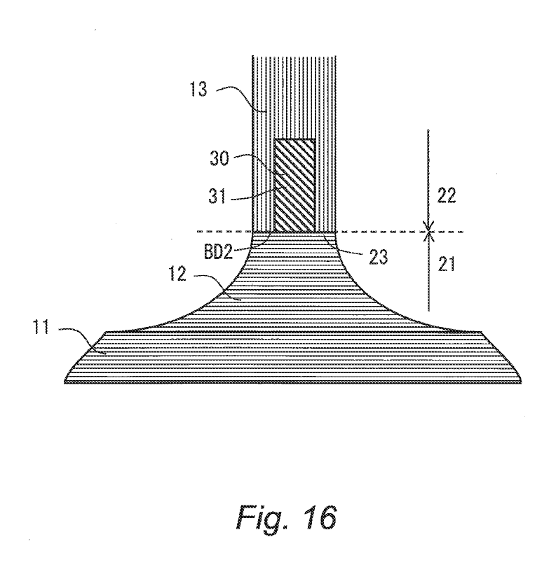

FIG. 16 shows another modification example of the structure of the intake valve 10 shown in FIG. 14. A hollow 30 is formed within the stem part 13 adjacent to the joint surface 23, as in the case shown in FIG. 15. In addition, the hollow 30 is filled with heat insulator 31. Due to existence of such the hollow 30 and heat insulator 31, the heat flow q2 towards the stem part 13 is further suppressed and thus the heat transfer towards the valve seat 5 is further facilitated.

What is claimed is:

1. An engine valve for an internal-combustion engine, comprising:
a head part comprising: a main surface facing a combustion chamber of the internal-combustion engine; and a valve face coming in contact with a valve seat;
a stem part extending along a direction of movement of the engine valve; and
a neck part between the head part and the stem part, wherein
a material of the stem part is heat-resistant steel, and
a material of the head part is aluminum or an aluminum alloy.

2. An engine valve for an internal-combustion engine, comprising:
a head part comprising: a main surface facing a combustion chamber of the internal-combustion engine; and a valve face coming in contact with a valve seat;
a stem part extending along a direction of movement of the engine valve; and
a neck part between the head part and the stem part, wherein
a material of the stem part is heat-resistant steel, and
a material of the head part is any of tungsten steel, chrome steel, low-chrome steel, and low-carbon steel.

3. An engine valve for an internal-combustion engine, comprising:
a head part comprising: a main surface facing a combustion chamber of the internal-combustion engine; and a valve face coming in contact with a valve seat;
a stem part extending along a direction of movement of the engine valve; and
a neck part between the head part and the stem part, wherein
a material of the stem part is heat-resistant steel, and
an inverse of thermal conductivity of a material of the head part at 100 degrees centigrade is in a range of 0.01 (m*K/W) to 0.04 (m*K/W).

4. The engine valve according to claim 1, wherein
a part made of the material of the head part is a first material part,
a part made of the material of the stem part is a second material part, and
a joint surface between the first material part and the second material part is located at a boundary between the head part and the neck part.

5. The engine valve according to claim 1, wherein
a part made of the material of the head part is a first material part,
a part made of the material of the stem part is a second material part, and
a joint surface between the first material part and the second material part is located at a middle of the neck part.

6. The engine valve according to claim 1, wherein
a part made of the material of the head part is a first material part,
a part made of the material of the stem part is a second material part, and
a joint surface between the first material part and the second material part is located at a boundary between the neck part and the stem part.

7. The engine valve according to claim 6, wherein
a hollow exists within the stem part adjacent to the joint surface.

8. The engine valve according to claim 6, wherein
a heat insulator exists within the stem part adjacent to the joint surface.

9. The engine valve according to claim 2, wherein
a part made of the material of the head part is a first material part,
a part made of the material of the stem part is a second material part, and
a joint surface between the first material part and the second material part is located at a boundary between the head part and the neck part.

10. The engine valve according to claim 2, wherein
a part made of the material of the head part is a first material part,
a part made of the material of the stem part is a second material part, and
a joint surface between the first material part and the second material part is located at a middle of the neck part.

11. The engine valve according to claim 2, wherein
a part made of the material of the head part is a first material part,
a part made of the material of the stem part is a second material part, and
a joint surface between the first material part and the second material part is located at a boundary between the neck part and the stem part.

12. The engine valve according to claim 11, wherein
a hollow exists within the stem part adjacent to the joint surface.

13. The engine valve according to claim 11, wherein
a heat insulator exists within the stem part adjacent to the joint surface.

14. The engine valve according to claim 3, wherein
a part made of the material of the head part is a first material part,
a part made of the material of the stem part is a second material part, and
a joint surface between the first material part and the second material part is located at a boundary between the head part and the neck part.

15. The engine valve according to claim 3, wherein
a part made of the material of the head part is a first material part,
a part made of the material of the stem part is a second material part, and
a joint surface between the first material part and the second material part is located at a middle of the neck part.

16. The engine valve according to claim 3, wherein
a part made of the material of the head part is a first material part,
a part made of the material of the stem part is a second material part, and
a joint surface between the first material part and the second material part is located at a boundary between the neck part and the stem part.

17. The engine valve according to claim 16, wherein
a hollow exists within the stem part adjacent to the joint surface.

18. The engine valve according to claim 16, wherein
a heat insulator exists within the stem part adjacent to the joint surface.
